(19) United States
(12) Patent Application Publication
(10) Pub. No.: US 2011/0188145 A1
(43) Pub. Date: Aug. 4, 2011

(54) SERVO TRACK WRITER AND OPERATING METHOD

(75) Inventors: Ha Yong KIM, Seoul (KR); Kyung Ho KIM, Seoul (KR); Kyu Nam CHO, Seoul (KR); Cheol-Soon KIM, Anyang-si (KR)

(73) Assignee: SAMSUNG ELECTRONICS CO., LTD., Suwon-si (KR)

(21) Appl. No.: 13/008,419

(22) Filed: Jan. 18, 2011

(30) Foreign Application Priority Data
Feb. 4, 2010 (KR) 10-2010-0010202

(51) Int. Cl. G11B 5/09

(52) U.S. Cl. 360/46; 360/51; G9B/5.219

(57) ABSTRACT

A method of operating a servo track writer includes writing a clock pattern signal to a magnetic recording medium of a head disk assembly, reading the clock pattern signal written to the magnetic recording medium and dividing a frequency of a read clock pattern signal, and supplying a clock pattern signal having a divided frequency to a spindle motor for rotating the magnetic recording medium.

### CROSS-REFERENCE TO RELATED APPLICATIONS

This application claims priority under 35 U.S.C. §119 to Korean Patent Application No. 10-2010-0010202 filed on Feb. 4, 2010, the subject matter of which is hereby incorporated by reference.

### BACKGROUND

The inventive concept relates to a servo track writer, and more particularly, to servo track writers capable of reducing the jitter generated by turbulence of a spindle motor rotating a disk embodied in a head disk assembly. The inventive concept also relates to methods of operating servo track writers similarly reducing jitter.

In general, the hard disk drive (HDD), which is commonly used, for example, as an auxiliary storage device in computers, is a device capable of recording data on a disk and/or reproducing recorded data from the disk by means of a magnetic head positioned over a track of data on the disk.

A servo track writer is a device configured to write a servo pattern to the disk. The servo pattern is a defined collection of servo information used by the magnetic head to correctly position itself over a selected track. The servo pattern is typically written to a specifically designated location on the disk called the servo sector. Thus, the HDD essentially control the positioning of the constituent magnetic head in relation to the servo pattern written to the disk.

The magnetic head of the servo track writer is configured to write the servo pattern on the disk as the disk is rotated by the spindle motor within the HDD and as the magnetic head floats above the surface of the disk at a relatively low flying height. Given this servo pattern writing configuration, it is little wonder that turbulence generated between the flying magnetic head and the rotating disk will adversely affect the overall quality of the recorded servo data.

### SUMMARY

The inventive concept provides a servo track writer (and related method of operating) capable of reducing servo data recording jitter conventionally caused by the turbulence generated by rotation of a disk by a spindle motor.

According to an aspect of the inventive concept, there is provided a method of operating a servo track writer, the method including; writing a clock pattern signal to a magnetic recording medium of a head disk assembly, reading the clock pattern signal written to the magnetic recording medium, dividing a frequency of the clock pattern signal, and providing a clock pattern signal having a divided frequency to a spindle motor that rotates the magnetic recording medium.

The method may further include generating a servo pattern signal using a frequency of the clock pattern signal as a reference frequency and writing a generated servo pattern signal to the magnetic recording medium.

According to another aspect of the inventive concept, there is provided a method of operating a servo track writer, the method including writing a clock pattern signal to a magnetic recording medium of a head disk assembly, reading the clock pattern signal written to the magnetic recording medium, and providing a read clock pattern signal to a spindle motor that rotates the magnetic recording medium.

The method may further include multiplying the read clock pattern signal having a given frequency, and writing a servo pattern signal to the magnetic recording medium using a clock pattern signal having a multiplied frequency of the given frequency.

According to another aspect of the inventive concept, there is provided a servo track writer including a magnetic head that reads a clock pattern signal written to a magnetic recording medium, a pre-amplifier that amplifies a clock pattern signal read by the magnetic head, a frequency divider that divides a frequency of a clock pattern signal amplified by the pre-amplifier, and a driver that controls an operating speed for a spindle motor that rotates the magnetic recording medium in response to the clock pattern signal output from the frequency divider.

The servo track writer may further include a pattern generator for generating a servo pattern signal according to the amplifier clock pattern signal.

According to another aspect of the inventive concept, there is provided a servo track writer including a magnetic head that reads a clock pattern signal written to a magnetic recording medium, a pre-amplifier that amplifies and provides a clock pattern signal read by the magnetic head, and a driver that controls an operating speed for a spindle motor that rotates the magnetic recording medium in response to a clock pattern signal amplified by the pre-amplifier.

The servo track writer may further include a frequency multiplier that multiplies a frequency of the clock pattern signal amplified by the pre-amplifier, and a pattern generator that generates a servo pattern signal according to a clock pattern signal output from the frequency multiplier.

The servo track writer may further include a phase locked loop having a frequency divider that divides a frequency of the clock pattern signal amplified by the pre-amplifier, and a pattern generator for generating a servo pattern signal according to a clock pattern signal output from the phase locked loop.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a system including a servo track writer according to an embodiment of the inventive concept;

FIG. 2 is a flowchart summarizing one possible operating method for the servo track writer of FIG. 1;

FIGS. 3A and 3B are respectively waveform diagrams of an input clock pattern signal and an output clock pattern signal provided by the frequency divider of FIG. 1;

FIG. 4 is a block diagram of a system including a servo track writer according to another embodiment of the inventive concept;

FIG. 5 is a flowchart summarizing another possible method of operating the servo track writer of FIG. 4; and

FIGS. 6A and 6B are respectively waveform diagrams of an input clock pattern signal and an output clock pattern signal provided by the frequency divider of FIG. 4.

### DETAILED DESCRIPTION OF THE EMBODIMENTS

The attached drawings for illustrating embodiments of the inventive concept are referred to in order to gain a sufficient understanding of the inventive concept and the merits thereof. Hereinafter, the inventive concept will be described in some additional with reference to the illustrated embodiments. Throughout the drawings and written description, like reference numbers and labels are used to denote like or similar elements.

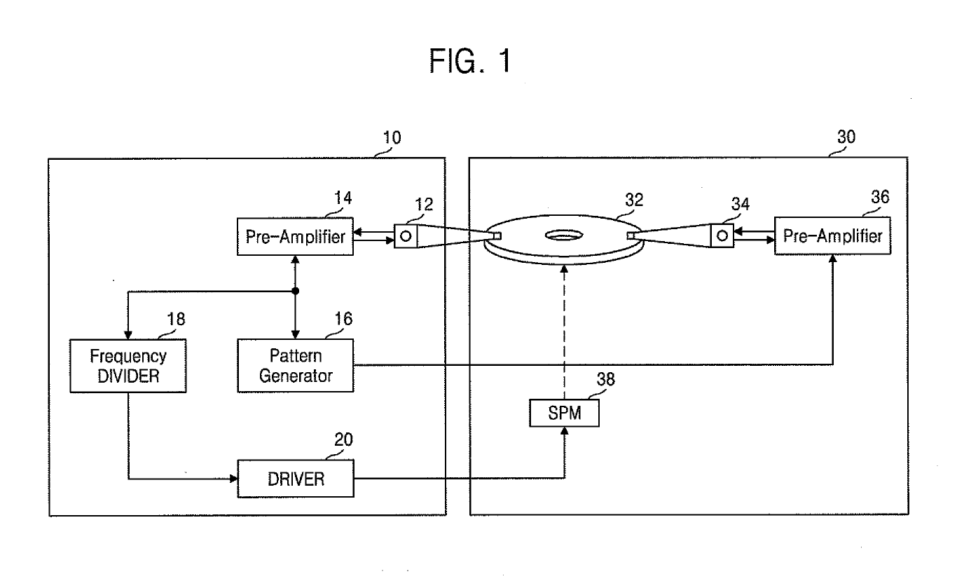

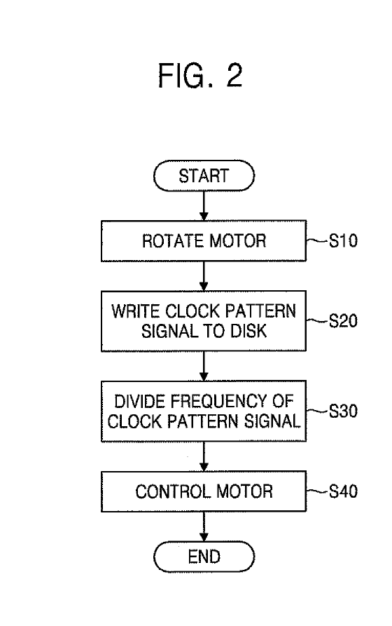

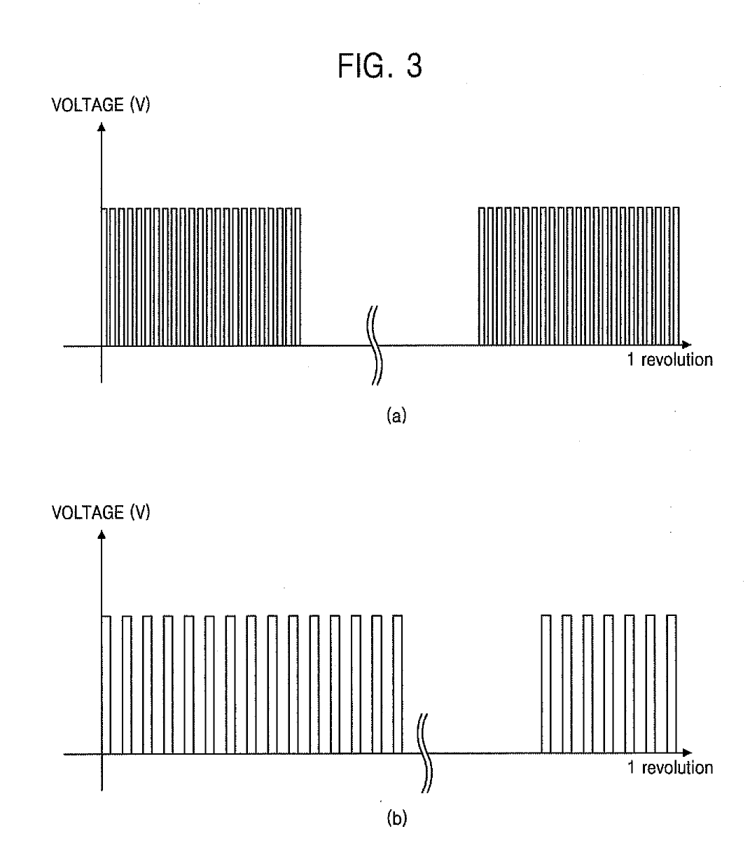

Figure (FIG.) 1 is a block diagram of a system including a servo track writer 10 according to an embodiment of the inventive concept. FIG. 2 is a flowchart summarizing one possible method of operating the servo track writer of FIG. 1. FIGS. 3A and 3B are respectively waveform diagrams of an input clock pattern signal and an output clock pattern signal provide by the frequency divider of FIG. 1.

Referring to FIG. 1, a system according to the illustrated embodiment comprises the servo track writer 10 configured to write a servo pattern signal to a disk 32 of the head disk assembly (HDA) 30. The disk 32 is described as but one example of magnetic recording media that may be used in various embodiments of the inventive concept.

In the illustrated embodiment of FIG. 1, the servo track writer 10 writes a plurality of clock pattern signals to the disk 32 as it is rotated by a spindle motor (SPM) 38. The servo track writer 10 generally comprises a magnetic head 12, a pre-amplifier 14, a pattern generator 16, a frequency divider 18, and a driver 20.

Certain clock pattern signals may be used as a reference signal or a reference time signal when a servo pattern signal is written to the disk 32 by servo track writer 10. For example, each of the clock pattern signals may include a plurality of pulses.

Referring now to FIGS. 1 and 2, operation of the system begins as the SPM 38 rotates the disk 32 under the control of the driver 20 once the HDA 30 is properly installed on the servo track writer 10 (S10). Within this operative assembly, the magnetic head 12 writes the clock pattern signals, as amplified by the pre-amplifier 14, to the disk 32 (S20). In certain embodiments of the inventive concept (e.g.,), the clock pattern signals include several tens of thousands of clock pattern signals. The clock pattern signals are generated by the pattern generator 16 and supplied to the pre-amplifier 14.

Using a spiral positioning pattern during a servo track writing operation, the magnetic head 12 reads at least one clock pattern signal from the disk 32 and transmits a corresponding clock pattern signal output to the pre-amplifier 14. The spiral positioning pattern of the servo track writing (or reading) operation is defined on the disk 32 for the clock pattern signal by the rotation of the disk and the movement of the magnetic head 12. The clock pattern signal output, as amplified by the pre-amplifier 14, is transmitted to the pattern generator 16 and the frequency divider 18.

The frequency divider 18 divides the frequency of the clock pattern signal output provide by the pre-amplifier 14 according to a predetermined division ratio, and then outputs a corresponding divided clock pattern signal output (S30). The predetermined division ratio may be controlled according to an externally provided control signal applied to the frequency divider 18. FIG. 3A illustrates a waveform for one possible clock pattern signal output provide by the pre-amplifier 14, and FIG. 3B illustrates a waveform of a corresponding divided clock pattern signal output.

The driver 20 is configured to drive or rotate the spindle motor 38 within the HDA 30 in response to the divided clock pattern signal output provided by the frequency divider 18. Thus, the driver 20 controls the rotation of the disk imparted by the spindle motor 38 (S40) in response to the divided clock pattern signal output.

The pattern generator 16 may be configured to transmit a generated servo pattern signal to a pre-amplifier 36 of the HDA 30 according to the clock pattern signal output provided by the pre-amplifier 14. In this manner, the magnetic head 34 of the HDA 30 writes a servo pattern signal as provided by the pre-amplifier 36 to the disk 32. The number of pulses included in the divided clock pattern signal output corresponds to the sampling frequency used to control the spindle motor 38.

A conventional servo pattern writer uses between 4 and 6 pulses corresponding to a back EMF signal generated by the spindle motor 38 to drive the spindle motor 38 with a constant velocity control. For example, if the spindle motor 38 rotates at 5400 rpm and the rotation of the spindle motor 38 is controlled using 6 pulses, the sampling frequency of the spindle motor 38 will be 540 Hz.

However, in the certain embodiments of the inventive concept, when the divided clock pattern signal output provided by the frequency divider 18 of the servo pattern writer 10 includes 256 pulses, and the spindle motor 38 rotates at 5400 rpm, then the sampling frequency of the spindle motor 38 is 23.04 KHz. As described above, since a controllable range for the rotational speed of the spindle motor 38 increases as the sampling frequency increases, not only may jitter be reduced, but also the spindle motor 38 may be better controlled operated with a constant speed.

That is, the servo track writer 10 according to certain embodiments of the inventive concept uses the frequency of a clock pattern signal output, and may therefore set a number of pulses to control the operating speed of the spindle motor 38 according to a sampling frequency that is much higher than the sampling frequency of similar conventional servo track writers. Thus, the servo track writer 10 may increase the sampling frequency corresponding to turbulence generated by the magnetic head 12 and the disk 32 so that the servo track writer 10 may be robust to the turbulence. Accordingly, since constant speed stability of the spindle motor 38 is improved, not only is jitter associated with the clock pattern signal written to the disk 32 reduced, but also quality of the servo pattern signal written to the disk 32 is improved.

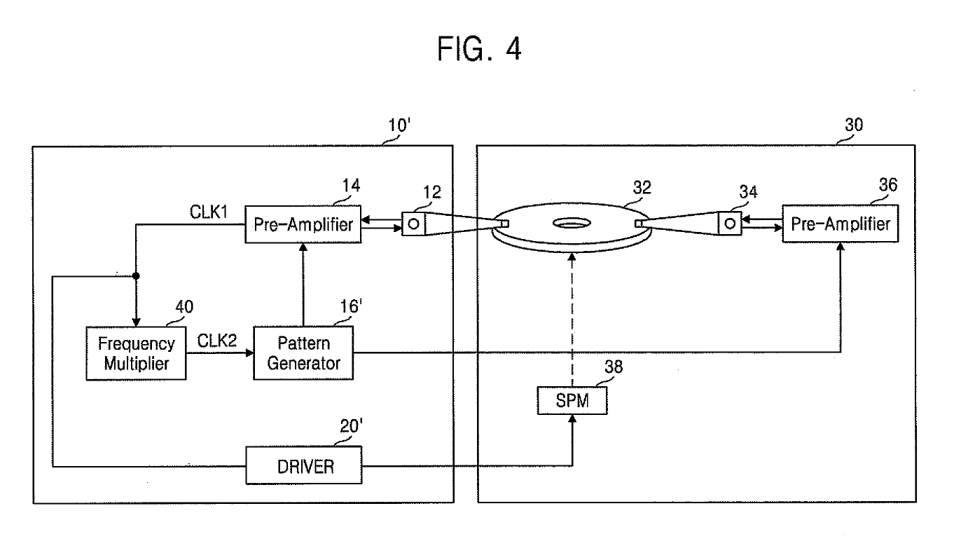

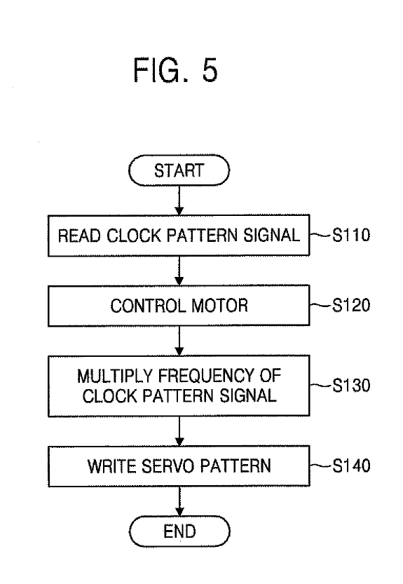

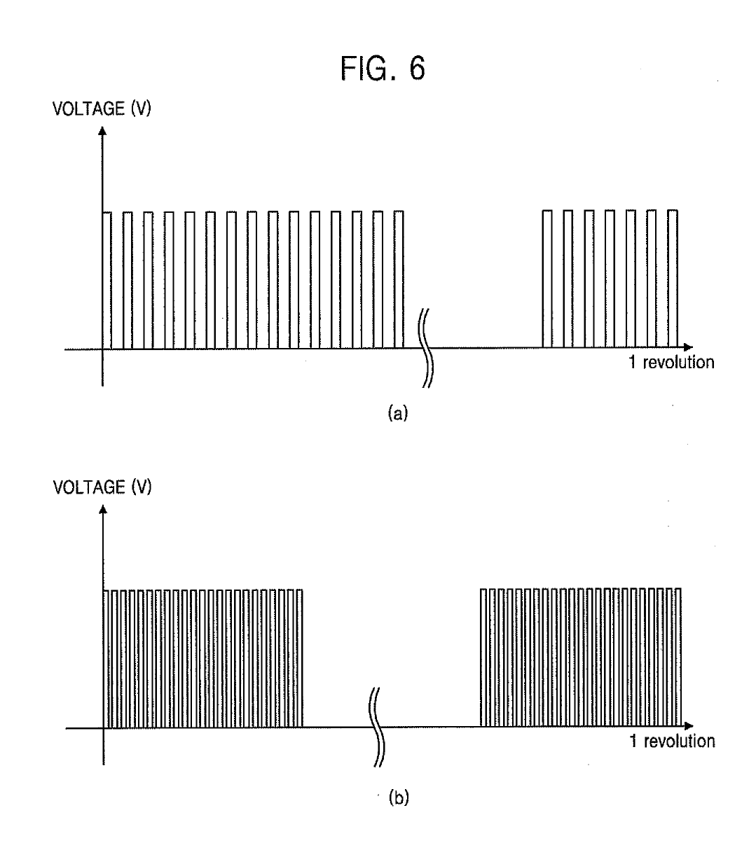

FIG. 4 is a block diagram of a system including a servo track writer 10′ according to an embodiment of the inventive concept. FIG. 5 is a flowchart summarizing one possible method of operating the servo track writer 10′ of FIG. 4. FIGS. 6A and 6B are respectively waveform diagrams for an input clock pattern signal and an output clock pattern signal of the frequency divider of FIG. 4.

Referring to FIG. 4, the servo track writer 10′ according to the illustrated embodiment comprises the magnetic head 12, the pre-amplifier 14, a pattern generator 16′, a frequency multiplier 40, and a driver 20′. The magnetic head 12 writes a plurality of clock pattern signals amplified by the pre-amplifier 14 to the disk 32 as it is rotated by the spindle motor 38. For example, when several tens of thousands of clock pattern signals are written to the disk 32 of FIG. 1, several thousands of the clock pattern signals may be written to the disk 32 of FIG. 4. When writing the servo pattern signals to the disk 32, the servo track writer 10′ uses a multiplied clock pattern signal generated by the frequency multiplier 40.

The magnetic head 12 reads at least one clock pattern signal CLK1 written to the disk 32 and transmits the at least one clock pattern signal CLK1 to the pre-amplifier 14 (S110). The driver 20′ controls the speed of the spindle motor 38 according to the clock pattern signal CLK1, as amplified and provided by the pre-amplifier 14 (S120).

The frequency multiplier 40 multiplies the frequency of the clock pattern signal CLK1 amplified by the pre-amplifier 14 by N times, and outputs a multiplied clock pattern signal CLK2 having an N-times multiplied frequency to the pattern generator 15′ (S130).

In certain embodiments of the inventive concept, the frequency multiplier 40 may be embodied by a phase locked loop with a frequency divider at a feedback loop and performing a function as a frequency multiplier. In other embodiments, the frequency multiplier 40 may be embodied by a frequency synthesizer, for example, an integer-N synthesizer. FIG. 6A illustrates a waveform of the clock pattern signal CLK1 amplified by the pre-amplifier 14. FIG. 6B illustrates a waveform of the multiplied clock pattern signal CLK2.

The pattern generator 16′ generates a servo pattern signal using the multiplied clock pattern signal CLK2 as a reference frequency and transmits a generated servo pattern signal to the pre-amplifier 36. The magnetic head 34 writes the servo pattern signal amplified by the pre-amplifier 36 to the disk 32 as it is rotated by the spindle motor 38 (S140). In certain embodiments, the magnetic head 32 may be replaced by an optical head configured to write an amplified servo pattern to the disk 32.

As illustrated in FIG. 4, the servo track writer 10′ controls a constant speed operation of the spindle motor 38 using the clock pattern signal CLK1 having a low frequency, and writes a servo pattern signal to the disk 32 using the multiplied clock pattern signal CLK2 having a high frequency.

As illustrated in FIG. 4, the servo track writer 10′ may set the number of pulses for controlling the operating speed of the spindle motor 38. That is, the sampling frequency used to control the operating speed of the spindle motor 38 may be materially higher than the sampling frequency used to control similar, conventional servo track writers. Thus, the servo track writer 10′ may increase the sampling frequency corresponding to turbulence generated by the magnetic head 12 and the disk 32 so that the servo track writer 10′ may be robust to the turbulence. Accordingly, since constant speed stability of the spindle motor 38 is improved, not only may the jitter of the clock pattern signal written to the disk 32 be reduced, but also the quality of the servo pattern signal written to the disk 32 may be improved.

As described above, a servo track writer according to embodiments of the inventive concept may reduce turbulence caused by spindle motor rotation within a head disk assembly during a servo track writing operation. Thus, quality of the resulting servo pattern signal may be improved.

While the inventive concept has been particularly shown and described with reference to exemplary embodiments thereof, it will be understood that various changes in form and details may be made therein without departing from the scope of the following claims.

What is claimed is:

1. A method of operating a servo track writer, the method comprising:
writing a clock pattern signal to a magnetic recording medium of a head disk assembly;
reading the clock pattern signal written to the magnetic recording medium and dividing a frequency of the read clock pattern signal; and
providing a clock pattern signal having a divided frequency to a spindle motor configured to rotate the magnetic recording medium.

2. The method of claim 1, further comprising:
generating a servo pattern signal using a frequency of the read clock pattern signal as a reference frequency; and
writing the servo pattern signal to the magnetic recording medium.

3. A method of operating a servo track writer, the method comprising:
writing a clock pattern signal to a magnetic recording medium of a head disk assembly; and
reading the clock pattern signal written to the magnetic recording medium and providing a read clock pattern signal to a spindle motor configured to rotate the magnetic recording medium.

4. The method of claim 3, further comprising:
multiplying the read clock pattern signal to generate a clock pattern signal having a multiplied frequency; and
writing a servo pattern signal to the magnetic recording medium using the clock pattern signal having the multiplied frequency.

5. A servo track writer comprising:
a magnetic head that reads a clock pattern signal written to a magnetic recording medium;
a pre-amplifier that amplifies the clock pattern signal and provides a clock pattern signal output;
a frequency divider that divides a frequency of the clock pattern signal output to generate a divided clock pattern signal; and
a driver that controls an operating speed of a spindle motor that rotates the magnetic recording medium in response to the divided clock pattern signal output.

6. The servo track writer of claim 5, further comprising:
a pattern generator that generates a servo pattern signal according to the divided clock pattern signal output.

7. A servo track writer comprising:
a magnetic head that reads a clock pattern signal written to a magnetic recording medium;
a pre-amplifier that amplifies the clock pattern signal read by the magnetic head to generate a clock pattern signal output; and
a driver that controls an operating speed for a spindle motor that rotates the magnetic recording medium in response to the clock pattern signal output.

8. The servo track writer of claim 7, further comprising:
a frequency multiplier that multiplies a frequency of the clock pattern signal output to generate a clock pattern signal output having an multiplied frequency; and
a pattern generator that generates a servo pattern signal in response to the clock pattern signal output having the multiplied frequency.

9. The servo track writer of claim 7, further comprising:
a phase locked loop including a frequency divider that divides a frequency of the clock pattern signal output to generate a clock pattern signal output having a divided frequency; and
a pattern generator that generates a servo pattern signal in response to the clock pattern signal output having the divided frequency.
